(19) United States
(12) Patent Application Publication
(10) Pub. No.: US 2014/0091753 A1
(43) Pub. Date: Apr. 3, 2014

(54) GATEWAY APPARATUS, METHOD THEREOF AND CHARGE/DISCHARGE SYSTEM

(71) Applicant: KABUSHIKI KAISHA TOSHIBA, Tokyo (JP)

(72) Inventors: Yuki YONEZAWA, Kawasaki-Shi (JP); Yasuyuki NISHIBAYASHI, Kawasaki-Shi (JP); Keiichi TERAMOTO, Tokyo (JP); Kotaro ISE, Kanagawa-Shi (JP)

(73) Assignee: KABUSHIKI KAISHA TOSHIBA, Tokyo (JP)

(21) Appl. No.: 14/038,055

(22) Filed: Sep. 26, 2013

(30) Foreign Application Priority Data
Oct. 1, 2012 (JP) 2012-219705

(51) Int. Cl. H02J 7/00

(52) U.S. Cl. CPC H02J 7/0068
USPC 320/107

(57) ABSTRACT

A gateway apparatus includes a managing unit, an assigning unit, a receiving unit, a generating unit and a transmitting unit. The managing unit manages at least one storage battery group including a set of one or more storage battery systems selected from a plurality of storage battery systems. The assigning unit assigns a first storage battery group, which is one of the at least one storage battery group, to a first charge/discharge instruction apparatus. The receiving unit receives an instruction related to charge or discharge from the first charge/discharge instruction apparatus. The generating unit generates a first control order that is a control order for the storage battery systems belonging to the first storage battery group, based on the instruction. The transmitting unit transmits the first control order to the storage battery systems belonging to the first storage battery group.

### CROSS REFERENCE TO RELATED APPLICATIONS

This application is based upon and claims the benefit of priority from the prior Japanese Patent Application No. 2012-219705 filed on Oct. 1, 2012, the entire contents of which are incorporated herein by reference.

### FIELD

Embodiments described herein relate to a gateway apparatus, a method thereof and a charge/discharge system.

### BACKGROUND

There is known a system in which a plurality of storage battery systems are connected with a gateway that aggregates such storage battery systems. Given such a system, consider a larger-scale system having a three-layer structure with a plurality of EMS's (hereinafter referred to as “higher-order charge/discharge instruction apparatuses”) added above the gateway.

It is conceivable that the gateway be connected to the plurality of storage battery systems and the plurality of higher-order charge/discharge instruction apparatuses, respectively, to handle a set of the plurality of storage battery systems as one virtual storage battery and assign the virtual storage battery to the plurality of higher-order charge/discharge instruction apparatuses. In this case, there are some problems.

For example, due to an operational constraint caused by commonalization and use of the plurality of storage battery systems as one virtual battery, there is a problem of occurrence of collision because simultaneous execution of instructions issued from the plurality of higher-order charge/discharge instruction apparatuses cannot be provided. Especially, there is an electrical constraint of inability of a storage battery to perform charge and discharge at the same time.

In the related art, there is known a charge/discharge control procedure in a battery charger that collectively controls a plurality of storage batteries connected via a CAN (Controller Area Network) bus. The storage batteries and the EMS have a many-to-one relationship. Also, as another related art, there is known a charge/discharge control procedure in a battery charger to set an operation plan to a storage battery. The storage battery and the EMS have a one-to-one relationship.

Even by any of these related arts, it is not possible to solve the above-mentioned collision problem caused in a case where an EMS is added above a gateway.

### BRIEF DESCRIPTION OF THE DRAWINGS

FIG. 1 is a diagram depicting an overall system according to the present embodiment;

FIG. 2 is a diagram depicting a storage battery system according to the present embodiment;

FIG. 3 is a diagram depicting an EV system (or storage battery system) according to the present embodiment;

FIG. 4 is a diagram depicting an overall view of a charge/discharge system;

FIG. 5 is a sequence diagram related to the related art;

FIG. 6 is a block diagram of a gateway charge/discharge instruction apparatus according to the present embodiment;

FIG. 7 is a diagram depicting storage battery characteristic information according to the present embodiment;

FIG. 8 is a diagram depicting charge/discharge control information according to the present embodiment;

FIG. 9 is an outline diagram of charge/discharge group management according to the present embodiment;

FIG. 10 is an operation sequence diagram according to the first embodiment;

FIG. 11 is an outline diagram of charge/discharge group management according to the second embodiment;

FIG. 12 is an operation sequence diagram according to the second embodiment; and

FIG. 13 is an operation sequence diagram according to the third embodiment.

### DETAILED DESCRIPTION

According to some embodiments, there is provided a gateway apparatus including: a managing unit, an assigning unit, a receiving unit, a generating unit and a transmitting unit.

The managing unit manages at least one storage battery group including a set of one or more storage battery systems selected from a plurality of storage battery systems.

The assigning unit assigns a first storage battery group, which is one of the at least one storage battery group, to a first charge/discharge instruction apparatus.

The receiving unit receives an instruction related to charge or discharge from the first charge/discharge instruction apparatus.

The generating unit generates a first control order that is a control order for the storage battery systems belonging to the first storage battery group, based on the instruction.

The transmitting unit transmits the first control order to the storage battery systems belonging to the first storage battery group.

Hereinafter, embodiments will now be explained with reference to the accompanying drawings.

### First Embodiment

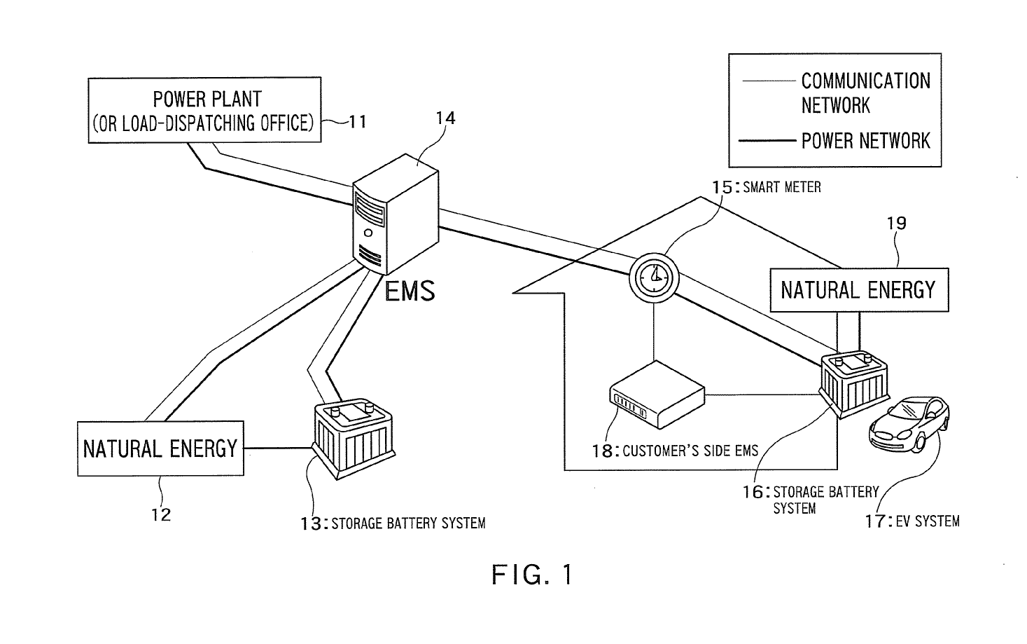

FIG. 1 presents the entire system according to the present embodiment.

In FIG. 1, on the power network side, there are provided a power plant (or load-dispatching office) 11, a natural energy system 12, a storage battery system (or higher-order storage battery system) 13 and a gateway charge/discharge instruction apparatus (or gateway apparatus) 14. The gateway charge/discharge instruction apparatus 14 corresponds to a storage battery SCADA (Supervisory Control and Data Acquisition). The gateway charge/discharge instruction apparatus 14 may have a function as an EMS (Energy Management System).

Also, on the customer side of a home or building, there are provided a smart meter 15, a storage battery system 16, an EV (Electric Vehicle) system 17, a customer's side EMS 18 and a natural energy system 19. As an EMS on the home customer side, there is an HEMS (Home Energy Management System). The storage battery system 16 and the EV (Electric Vehicle) system 17 correspond to an example of a lower-order storage battery system arranged on the customer side. Here, although only one customer is illustrated, actually, there may be a number of customers.

The power plant (or load-dispatching office) 11 generates a large amount of power by fuel sources such as thermal power and nuclear power, and supplies it to the side of customers such as homes, buildings and factories through transmission and distribution networks. In the present specification, the transmission and distribution networks from the power plant 11 to the customers are collectively referred to as “power system network.”

The natural energy system 12 generates power from energy existing in the natural world such as wind power and sunlight, and, in the same way as the power plant, supplies the power from the power system network to the customers through transmission and distribution networks. By installing the natural energy system 12 in the power system network, it is possible to reduce the burden in the power plant and efficiently perform an operation. Here, the high-order storage battery system 13 has a role to store surplus power generated in the power plant and the natural energy system.

The gateway charge/discharge instruction apparatus 14 has a role to perform control of stabilizing the whole power system including supply power of the power plant and the natural energy system and load power consumed on the customer side, using both a power network and a communication network. The power plant 11 corresponds to a high-order charge/discharge instruction apparatus for the gateway charge/discharge instruction apparatus 14. Here, only one high-order charge/discharge instruction apparatus is shown, but a plurality of high-order charge/discharge instruction apparatus may be arranged.

The smart meter 15 measures the electric energy consumed on the customer side premise and periodically reports it to a management server of an electric power provider. Generally, although the management server is referred to as “MDMS (Metering Data Management System),” its illustration is omitted in FIG. 1. The EMS as stated above can calculate the total amount of load power on the customer side in cooperation with the MDMS.

The storage battery system 16 installed in a customer's premise stores power supplied from the system network of the electric power provider or the natural energy system 25 on the premise.

The EV system 17 stores power in an in-vehicle battery through a battery charger. The HEMS performs adjustment control of the consumption energy in the home. The EV system is one form of storage battery system.

In the example in FIG. 1, although the customer is in a standard home, a building and a factory are possible. In this case, instead of the home HEMS, a BEMS (Building Energy Management System) in the building and a FEMS (Factory Management System) in the factory take a role of performing adjustment control of the power consumption amount in the equipment.

As the use on the system side of the electric power provider in the storage battery system (e.g., the storage battery system 13 in FIG. 1), a storage battery system is utilized to realize a function called “ancillary service” (i.e. short-period control). The ancillary service stabilizes a system by performing output adjustment on a second time scale according to instantaneous load changes in order to maintain the electrical quality such as system frequency or voltage.

Also, as the use of the storage battery system on the home or building customer side, it may be utilized to realize a function called “peak shift” (i.e. day operation). The peak shift stores nighttime power of a lower unit price to implement interchange in a time zone in which the diurnal power use is peak.

Also, in one structure, a relationship of a controlling entity relative to a storage battery system may be a one-to-one relationship by operationally putting limitations. For example, the limitations are put on an electric power provider in the case of installment on the system side, and a home or building manager in the case of installment on the customer side, for example. In addition, on condition that a certain incentive is given on the customer side, it is possible to consider a structure of a many-to-many relationship that electric power providers perform charge/discharge control of storage battery systems installed on the customer sides. The present embodiment is directed to a case where a plurality of electric power providers perform charge/discharge control of storage battery systems installed on a plurality of customer sides as described above.

As a storage battery system on the customer side, the following two models are possible.

One is a storage battery model used as a stationary type. The other is a model of an EV system used as vehicle installation.

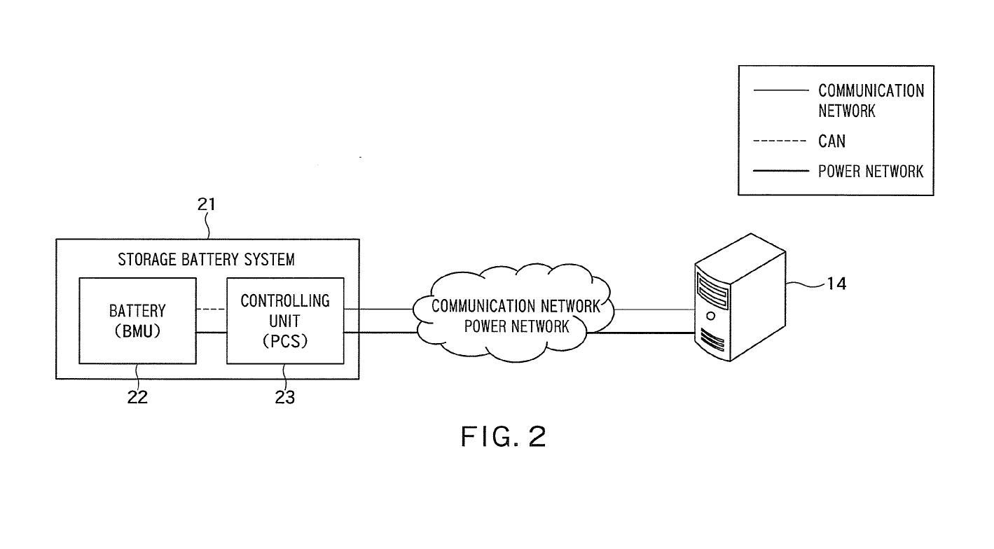

FIG. 2 illustrates a storage battery system 21 as an example of a storage battery model. The storage battery system 21 includes a BMU (Battery Management Unit) 22 and a controlling unit (or PCS (Power Conditioning System)) 23.

The storage battery (BMU) 22 includes multiple battery cells and an internal processor to manage the state inside a battery pack, and implements charge/discharge control of power based on a request from the controlling unit (PCS) 23. The storage battery (BMU) 22 reports information such as the rated voltage, the maximum current value at the time of discharge and charge, the SOC (State Of Charge) and the SOH (State Of Health) to the power electronics device 23. The controlling unit (PCS) performs direct-current/alternating-current conversion and voltage change suppression. Regarding procedures for the charge/discharge control and the information report between the storage battery (BMU) 22 and the power electronics device 23, there may be plural methods. The methods includes a method of realizing them using a CAN (Controller Area Network), and a method of realizing them using a communication medium such as Ethernet or an electrical signal line that is uniquely defined by a vendor who sells products. However, the embodiment is not limited to any communication unit.

The controlling unit (PCS) 23 has a communication function and communicates with the EMS (gateway charge/discharge instruction apparatus) 14 installed in the power system network. Generally, since a storage battery has a feature of self-discharge, by acquiring information such as SOC and SOH from the storage battery system 21 via the communication network, the EMS 14 can appropriately monitor the state that changes over time and instruct charge/discharge control. Here, in the description, an input/output of power with respect to the storage battery 22 in the storage battery system 21 is abbreviated and described as charge/discharge control with respect to the storage battery 22. Here, it is also conceivable that part or all of main functions of the controlling unit, such as a communication function, are realized on an external processor connected to a PCS.

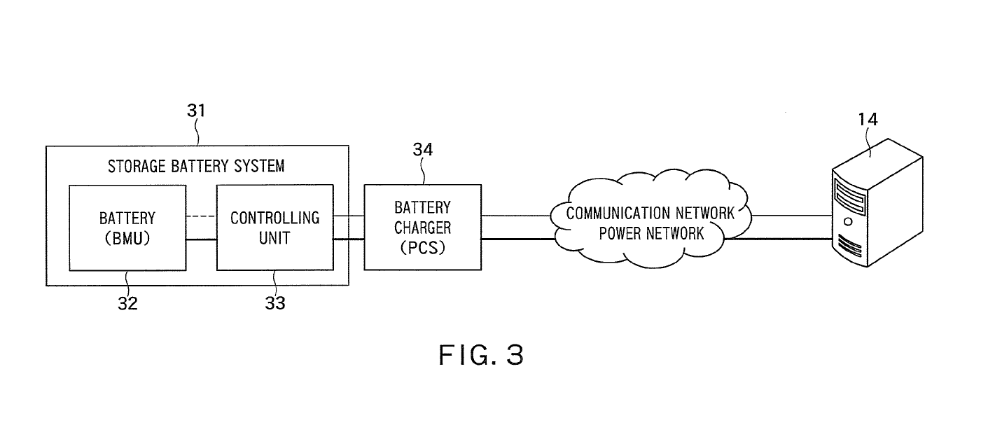

FIG. 3 illustrates an example of an EV system. An EV system 31 has a configuration similar to the storage battery system 21 in FIG. 2 but differs from it in that a battery charger (PCS) 34 is separately provided. A controlling unit 33 in the EV system 31 in FIG. 3 relays charge control and information report between a battery (BMU) 32 and a battery charger (PCS) 34, and does not mount a communication function to communicate with the EMS 14 on a power network. Instead, the battery charger 34 has main functions of the controlling unit 23 in the storage battery system in FIG. 2. That is, the EV system 31 in FIG. 3 has a feature that the main functions of the controlling unit 23 in the storage battery system 21 in FIG. 2 are moved to the battery charger 34.

A specific procedure to realize the first embodiment is common to the configurations as shown in FIG. 2 and FIG. 3, and, furthermore, the role of the controlling unit 33 in the EV system 31 can be defined to the same role as the controlling unit 23 of the storage battery system 21. Further, there are multiple formats as the installation destinations of algorithm processing related to discharge and charge with respect to the storage battery (BMU); the controlling unit, the battery charger and the HEMS/BEMS on a customer's premise or EMS in the power system network. The embodiment can be realized in the same framework even if any format is used.

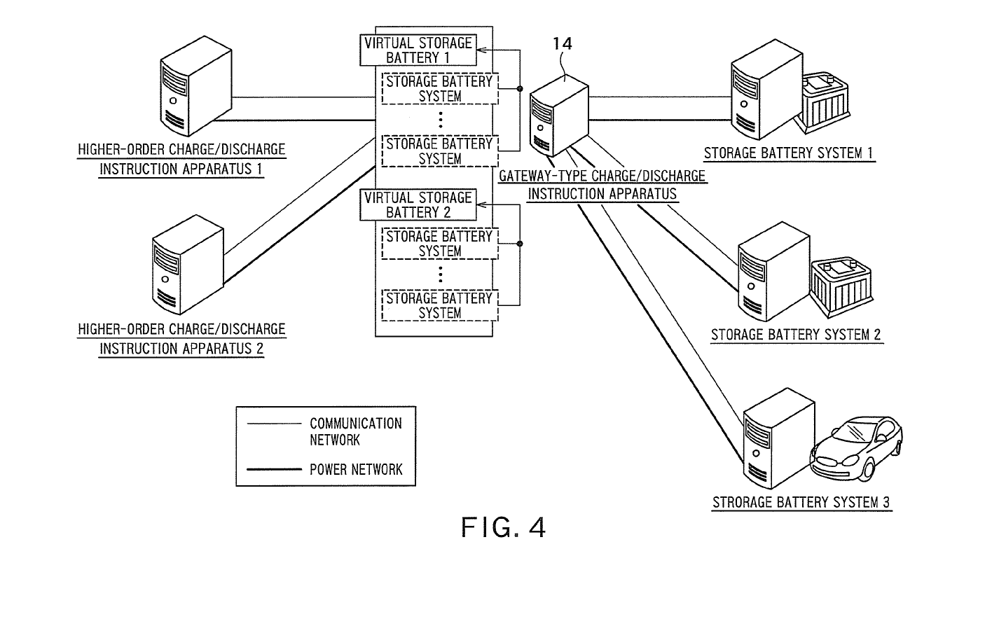

Using FIG. 4, an example of a use case assumed in the present embodiment will be explained. FIG. 4 illustrates a charge/discharge system according to the present embodiment. A configuration of the charge/discharge system includes three layers of: higher-order charge/discharge instruction apparatuses 1 and 2; a gateway charge/discharge instruction apparatus 14; and storage battery systems (i.e. lower-order storage battery systems) 1, 2 and 3 on the customer side.

Each of the higher-order charge/discharge instruction apparatuses 1 and 2 communicates with the gateway charge/discharge instruction apparatus 14. The gateway charge/discharge instruction apparatus 14 performs communication between each of the higher-order charge/discharge instruction apparatuses 1 and 2 and the storage battery systems 1, 2 and 3. The storage battery systems 1, 2 and 3 perform communication with the gateway charge/discharge instruction apparatus 14.

The gateway charge/discharge instruction apparatus 14 controls a plurality of battery storage systems based on instructions received from the higher-order charge/discharge instruction apparatuses 1 and 2.

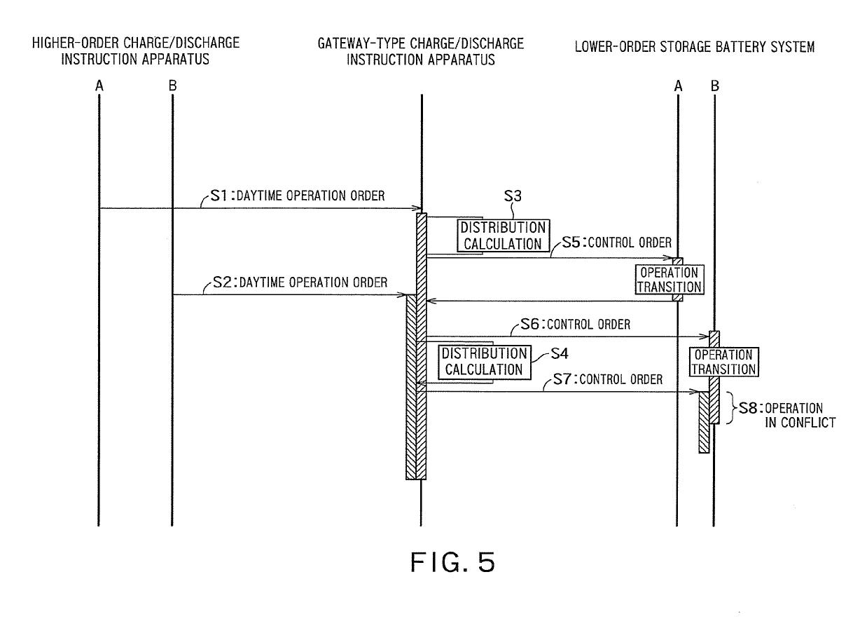

Here, there is a problem at the time when the gateway charge/discharge instruction apparatus controls the lower-order storage battery systems. As illustrated in FIG. 5, consider a case where orders indicating respective instructions are transmitted from a plurality of higher-order charge/discharge instruction apparatuses A and B to the gateway charge/discharge instruction apparatus (S1 and S2). For example, a daytime operation order (including, for example, information of time periods and charge/discharge amounts) related to plan information and individual charge/discharge instructions (including, for example, designation of real-time charge/discharge amounts) are provided. The gateway charge/discharge instruction apparatus performs each distribution calculation based on orders received from the higher-order charge/discharge instruction apparatuses A and B (S3 and S4). For example, it specifically calculates: from which storage battery system the discharge is performed; and to which equipment (e.g. a storage battery system on the system side/storage battery systems on other customers/power consumption apparatus) the discharge is directed. Further, it calculates: in which storage battery system the charge is performed; from which equipment (e.g. power plant/storage battery system on the system side/storage battery systems of other customers) the charge is performed; and how much charge is stored. According to the distribution calculation result with respect to the higher-order charge/discharge instruction apparatus A, control orders to the storage battery systems A and B are generated and transmitted (S5 and S6). Also, according to the distribution calculation result with respect to the higher-order charge/discharge instruction apparatus B, a control order to the storage battery system B is generated and transmitted (S7).

Here, as a communication message from the higher-order charge/discharge instruction apparatuses to the gateway charge/discharge instruction apparatus, the following two messages are possible.

The first one is to perform on-demand control, and, for example, controls a storage battery system in real time to prevent the instantaneous interruption of power supply in a power network. However, in the storage battery system, as an actual device in a customer home is operated, it is general that a delay occurs between the control operation transition start and the operation transition end. Therefore, when another on-demand control is further performed during the time, the operation depends on the design of the storage battery, which leads to a problem of unpredictable operation.

The second one is to perform planned control. For example, it is possible to allow the setting to implement control of a storage battery system at relatively gradual time periods in the night time zone, and can be used for a plan operation. However, in a case where totally different control orders are generated from a plurality of higher-order charge/discharge instruction apparatuses, it leads to a problem of totally different requests issued by a gateway charge/discharge instruction apparatus to storage battery systems so that operation instructions that cannot be executed are scheduled.

In the example in FIG. 5, a case is illustrated where charge and discharge ordered from the higher-order charge/discharge instruction apparatuses A and B overlap in the same time zone with respect to the storage battery system B and cannot be executed (S8).

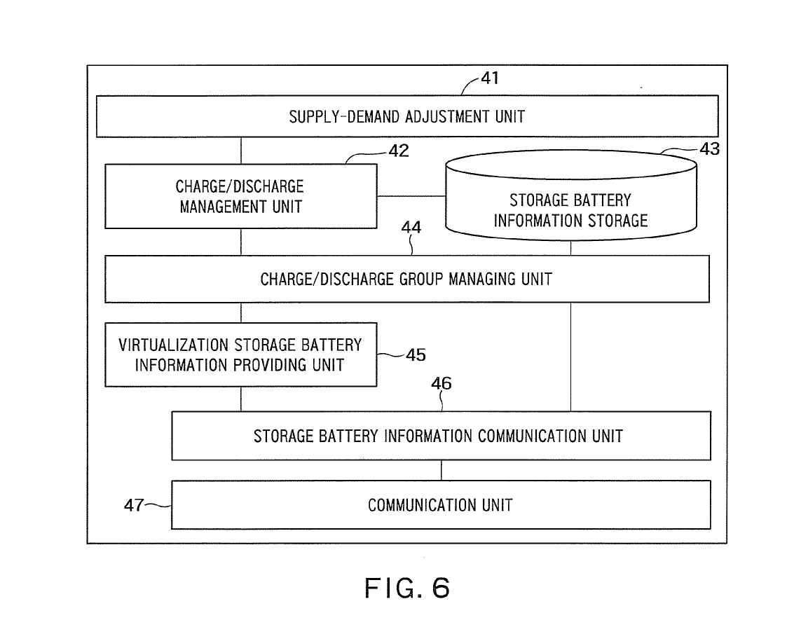

FIG. 6 illustrates a gateway charge/discharge instruction apparatus according to the present embodiment.

A supply-demand adjustment unit 41 monitors the supply energy and a frequency state in a system network of an electric power provider or in equipment on the customer side. Also, the supply-demand adjustment unit 41 adequately makes a decision to: instruct charge/discharge control to a lower-order or higher-order storage battery system to prevent the blackout due to shortage of power supply; or instruct charge control to the lower-order or higher-order storage battery to use excess power caused by excess power supply later.

The charge/discharge management unit 42 manages the total charge/discharge amount of a virtual storage battery, which is a group acquired by grouping (described later) in the charge/discharge group managing unit 44, and performs control related to discharge and charge. The charge/discharge management unit 42 manages a plurality of groups (i.e. virtual storage batteries) and instructs charge/discharge control every group while monitoring the state of supply-demand adjustment.

A charge/discharge control instruction designates the discharge/charge amount to a storage battery operating as an on-demand type and designates the charge/discharge amount and a time period to a storage battery operating as a plan type. Such a control instruction is transmitted, as a communication message, from a storage battery information communication unit 46 to a communication unit 47. In this case, like IEC 61850 as the standard for electricity infrastructure related to distributed power-supply control, the standard for buildings and the standard for domestic or European and American homes, it is preferable to switch and use a different data model/communication protocol every application place and apply charge/discharge control according to each standard specification. However, in the embodiment herein, naturally, it is not limited to specification requirements of a particular standard.

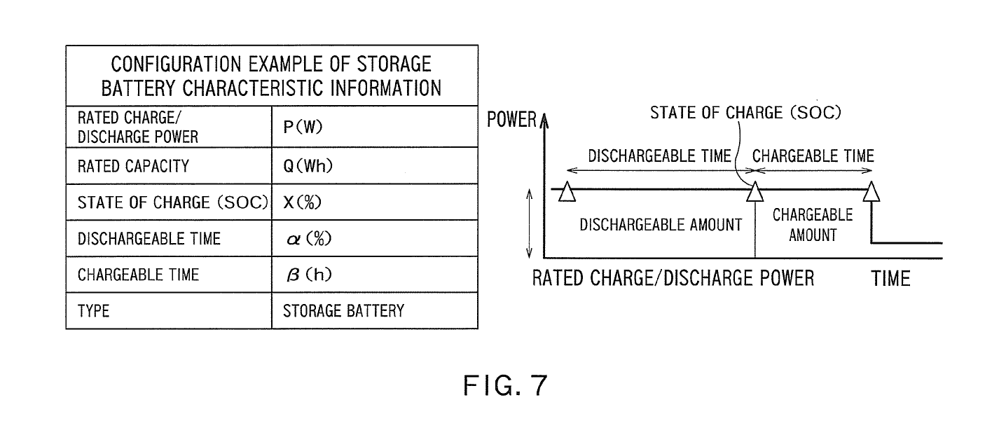

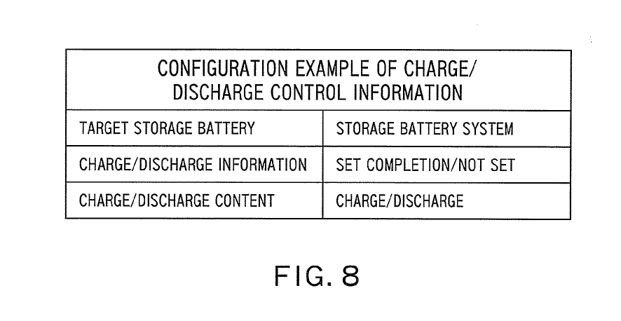

The battery power information storage 43 stores charge/discharge unique information as information required at the time of charge/discharge control of a battery unit (BMU). As charge/discharge unique information, there are storage battery characteristic information and charge/discharge control information. FIG. 7 illustrates an example of storage battery characteristic information and FIG. 8 illustrates an example of charge/discharge control information.

The example in FIG. 7 describes rated charge/discharge power expressed in W (Watt), rated capacity expressed in Wh (Watt hour), SOC (State Of Charge) expressed in percentage and dischargeable time and chargeable time associated with the SOC. In a constant current charge mode which is a general charge mode of a storage battery, the electric energy (i.e. current amount) input/output by battery cells in the storage battery (BMU) is at a constant rate until the SOC expressed in percentage reaches a predetermined threshold.

In view of this, as illustrated in the right side of FIG. 7, by acquiring a value of the SOC from the storage battery (BMU), the gateway charge/discharge instruction apparatus can calculate the chargeable time and dischargeable time (i.e. the horizontal axis of the graph), the maximum charge/discharge power (i.e. the vertical axis of the graph) and the electric energy required for discharge and charge (i.e. product of the dischargeable and chargeable time and the power), which are associated with that information. In constant current charge, there is a feature that the current amount required for charge is substantially reduced after the SOC is over the predetermined threshold.

Also, as the electric energy at the time of charge/discharge control, it is possible to use the current amount expressed in Ah (Ampere hour) and the voltage amount expressed in Vh (Volt hour) in addition to the electric energy expressed in Wh (Watt hour).

The charge/discharge control information in FIG. 8 is used to identify a charge/discharge operation state of a storage battery system. The “target storage battery” indicates identification information of the storage battery system. The “charge/discharge content” indicates which state of discharging, charging and others a storage battery is currently in. The “charge/discharge information” indicates who is currently using (discharging or charging) a storage battery. In a case where the storage battery is used on the system side (e.g. higher-order charge/discharge instruction apparatus), “set completion” is illustrated, and, in a case where the storage battery is used by the customer or charge/discharge is not performed, “not set” is illustrated.

Also, how to use the information in FIG. 7 and FIG. 8 and control discharge and charge is not an essence of the present embodiment and therefore detailed explanation is omitted.

The charge/discharge group managing unit 44 (managing unit, generating unit or assigning unit) groups and manages connected lower-order storage battery systems. Regarding a higher-order charge/discharge instruction apparatus, one or more storage battery systems as all or part of plural storage battery systems can be selected and combined to illustrate one virtual storage battery (or storage battery group). This corresponds to a function of a managing unit included in the charge/discharge group managing unit 44. The charge/discharge group managing unit 44 creates at least one virtual storage battery based on storage battery systems that are not being used by customers, for example. According to the customer usage state, a used storage battery system may be changed every time zone. Also, a group may be created based on storage battery systems that are not being charged or discharged. The charge/discharge group managing unit 44 creates the virtual storage battery in an arbitrary manner and assigns it to a higher-order charge/discharge instruction apparatus. The higher-order charge/discharge apparatus may not know information of individual storage battery systems in the group and may know the overall characteristic of the individual storage battery systems.

Also, the charge/discharge group managing unit 44 converts an order (e.g. plan information), which is transmitted from the higher-order charge/discharge instruction apparatus to the virtual storage battery, into control orders for the individual lower-order storage battery systems. Subsequently, the converted control order for each storage battery system is transmitted to the charge/discharge management unit 42 and the storage battery information storage 43 to implement control of the virtual storage battery. Such control order conversion (or generation) corresponds to a function of a generating unit included in the charge/discharge group managing unit 44.

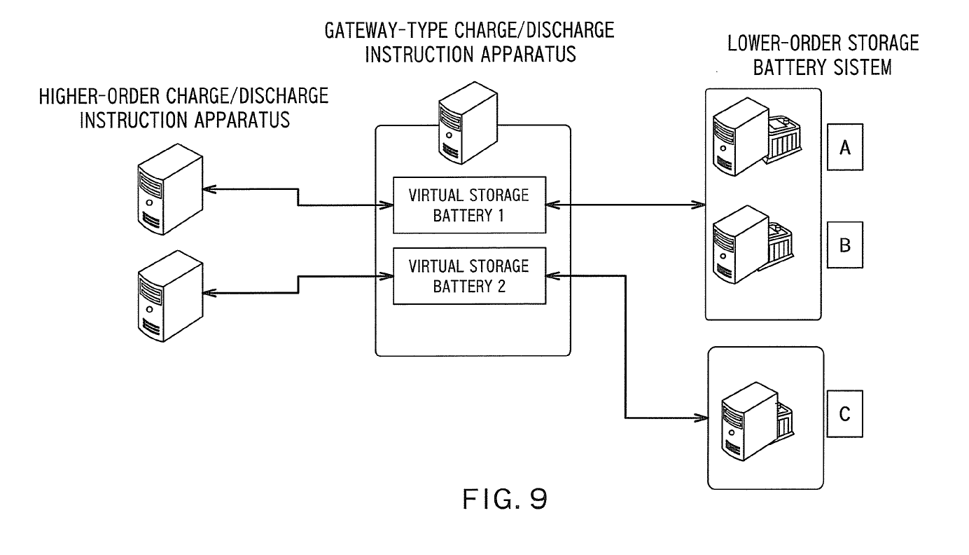

FIG. 9 illustrates details of virtual storage batteries (i.e. groups).

In the present embodiment, virtual storage batteries 1 and 2 target storage battery systems that do not overlap at all in a physical manner. Further, in a case where there are a plurality of higher-order charge/discharge instruction apparatuses, the virtual storage batteries the storage battery systems of which do not overlap in a physical manner are assigned to them. By this means, since exclusive processing of control orders between the virtual storage batteries is not required, it becomes easy to simplify a system.

A virtualization storage battery information providing unit aggregates a plurality of lower-order storage battery systems as a virtual storage battery and provides characteristic information and interface of the virtual storage battery to a higher-order charge/discharge instruction apparatus. The information shown for the higher-order charge/discharge instruction apparatus is given to the storage battery information communication unit 46. For generation of the characteristic information of the virtual storage battery, it is possible that various calculations are required. For example, there may be a method of calculating accurate data from electricity information of the grouped lower-order storage batteries and a method of calculating the power capacity that can be reliably provided by the virtual storage battery. The higher-order charge/discharge instruction apparatus regards the virtual storage battery as one storage battery. A plurality of virtual storage batteries may be previously generated and characteristic information and interfaces of all of these virtual storage batteries may be presented to the higher-order charge/discharge instruction apparatuses. The charge/discharge group managing unit 44 receives designation of a virtual storage battery desired to be assigned, from the higher-order charge/discharge instruction apparatus, and assigns the designated virtual storage battery. Alternatively, in response to a characteristic condition (e.g. power capacity) of a storage battery requested from the higher-order charge/discharge instruction apparatus, it may be possible to combine lower-order storage battery systems so as to satisfy the condition to thereby generate a virtual storage battery and assign the generated virtual storage battery. The above-mentioned virtual storage battery assignment corresponds to a function of an assigning unit included in the charge/discharge group managing unit 44.

The storage battery information communication unit 47 is used to receive a communication message related to electric energy information and access control of a battery unit (BMU) required for charge/discharge control, on a communication network via the communication unit 47. Regarding a communication message, like IEC 61850 as the standard for electricity infrastructure related to distributed power-supply control, the standard for buildings and the standard for domestic or European and American homes, it is preferable to switch and use a different data model/communication protocol every application place. However, in the embodiment herein, naturally, it is not limited to specification requirements of a particular standard.

The communication unit 47 can be realized by a wireless communication medium in addition to a wire communication medium such as an optical fiber, telephone line and Ethernet. However, the communication unit 47 in the embodiment herein does not depend on a specific communication medium. After receiving permission decision in access control from a lower-order storage battery system, a gateway charge/discharge instruction apparatus generates and transmits a communication message related to charge/discharge control. In such a control procedure between the gateway charge/discharge instruction apparatus and the lower-order storage battery system, although it may be possible to improve the safety by applying an authentication procedure, the embodiment herein does not depend on a specific form.

The gateway charge/discharge instruction apparatus operating as an EMS manages a plurality of groups which are virtual storage batteries. The gateway charge/discharge instruction apparatus instructs charge/discharge control every group while monitoring the state of supply-demand adjustment. A charge/discharge control instruction designates the discharge/charge amount to a storage battery operating as an on-demand type and designates the charge/discharge amount and a time period to a storage battery operating as a plan type. In the case of transmitting such a control instruction as a communication message via the storage battery information communication unit 46, like IEC 61850 as the standard for electricity infrastructure related to distributed power-supply control, the standard for buildings and the standard for domestic or European and American homes, it is preferable to switch and use a different data model/communication protocol every application place and apply charge/discharge control according to each standard specification. However, in the embodiment herein, naturally, it is not limited to specification requirements of a particular standard.

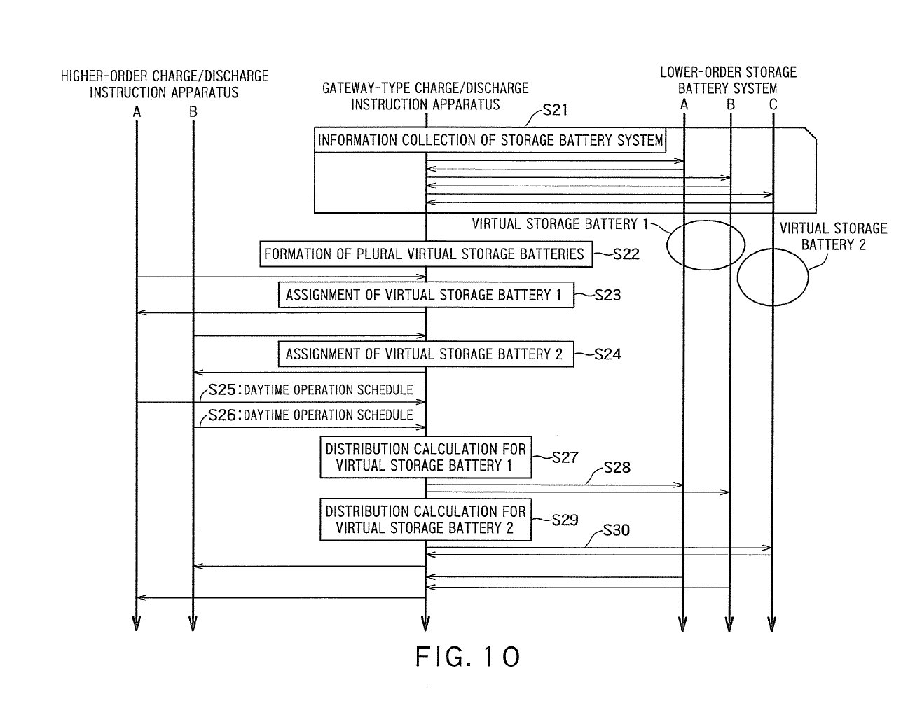

FIG. 10 illustrates an operation example of a gateway charge/discharge instruction apparatus according to the first embodiment.

There are two higher-order charge/discharge instruction apparatuses, one gateway charge/discharge instruction apparatus and three storage battery systems (i.e. lower-order storage battery systems) on the customer side.

First, the gateway charge/discharge instruction apparatus collects information of the storage battery systems A, B and C (S21).

Next, a virtual storage battery (i.e. storage battery group) is created by grouping one or more storage battery systems among the storage battery systems A, B and C. By repeating this several times, a plurality of virtual storage batteries 1 and 2 are created (S22). At this time, it is done such that the same storage battery system is not shared between the virtual storage batteries 1 and 2. As virtualization, with a constraint that they are not overlapped, there is a possible method of grouping to group specific power capacities in one unit or a method of grouping per power capacity requested by a higher-order charge/discharge instruction apparatus. The storage battery systems A and B are assigned to the virtual storage battery 1 and the storage battery system C is assigned to the virtual storage battery 2.

Subsequently, respective virtual storage batteries are assigned to the higher-order charge/discharge instruction apparatuses A and B. In the present example, the virtual storage battery 1 is assigned to the higher-order charge/discharge instruction apparatus A and the virtual storage battery 2 is assigned to the higher-order charge/discharge instruction apparatus B (S23 and S24). As a determination method of the assignment, it is possible to use an arbitrary method. For example, it may be possible to present the characteristic information and interface of each virtual storage battery to each higher-order charge/discharge instruction apparatus and make each apparatus select a virtual storage battery desired to be assigned. Also, it may be possible to accept designation of conditions such as the power capacity from each higher-order charge/discharge instruction apparatus and assign a virtual storage battery matching the conditions. Naturally, the assignment may be determined using other methods.

Finally, from the higher-order charge/discharge instruction apparatuses A and B, at the same time or before or after the time, an order indicating control content (e.g. plan information related to daytime operations and an on-demand charge/discharge instruction) with respect to each virtual storage battery is transmitted to the gateway charge/discharge instruction apparatus (S25 and S26). The gateway charge/discharge instruction apparatus performs distribution calculation with respect to each virtual storage battery (S27 and S29) and transmits control orders (S28 and S30).

In the above-mentioned operation example, although a virtual storage battery is assigned before receiving an order from a higher-order charge/discharge instruction apparatus, it is possible to receive desired battery conditions from the higher-order charge/discharge instruction apparatus and, at this timing, generate and assign a virtual storage battery satisfying the conditions (or assign a virtual storage battery previously generated).

As described above, according to the present embodiment, by grouping a plurality of storage battery systems so as not to be overlapped in a physical manner, managing them as virtual storage batteries and assigning respective virtual storage batteries to higher-order charge/discharge instruction apparatuses, it is possible to prevent a collision of control orders between storage battery systems. Therefore, it is possible to provide a large-scale system.

### Second Embodiment

The second embodiment is an embodiment in a case where storage battery systems belonging to a plurality of virtual storage batteries are allowed to overlap between the virtual storage batteries.

The present embodiment has a feature that, in a case where a first virtual storage battery is operating by an operation instruction of a first higher-order charge/discharge instruction apparatus, the first virtual storage battery does not accept an instruction related to control with respect to a second virtual storage battery that shares a common storage battery system with the first virtual storage battery, from the second higher-order charge/discharge instruction apparatus.

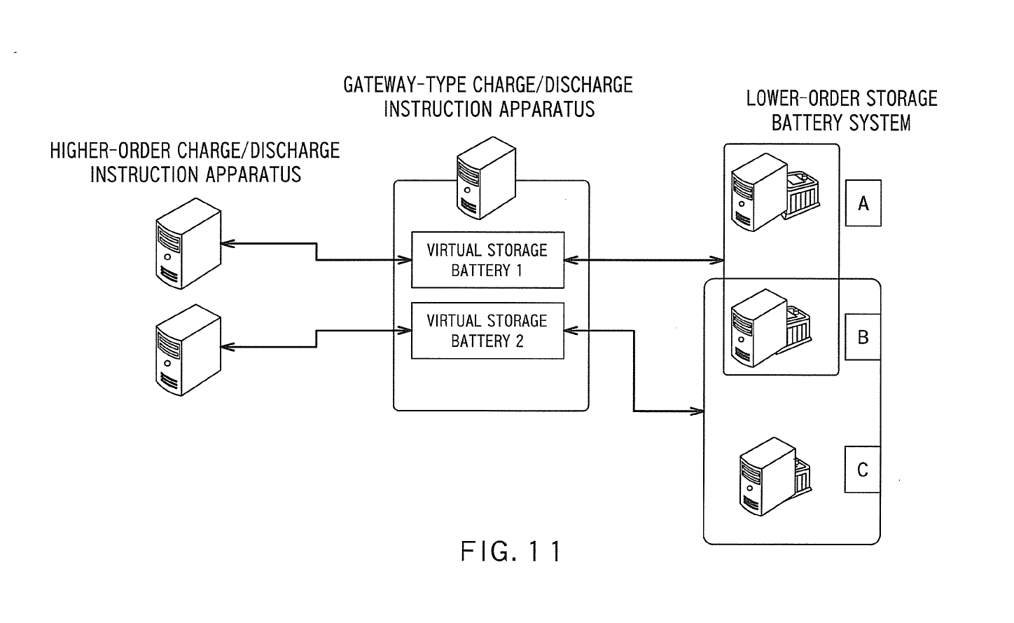

FIG. 11 illustrates an example of virtual storage batteries according to the present embodiment. A gateway charge/discharge instruction apparatus creates two virtual storage batteries 1 and 2 from lower-order storage battery systems A, B and C. The storage battery systems A and B are assigned to a virtual storage battery 1, and the storage battery systems B and C are assigned to a virtual storage battery 2. The storage battery system B is commonly used between the virtual storage batteries 1 and 2.

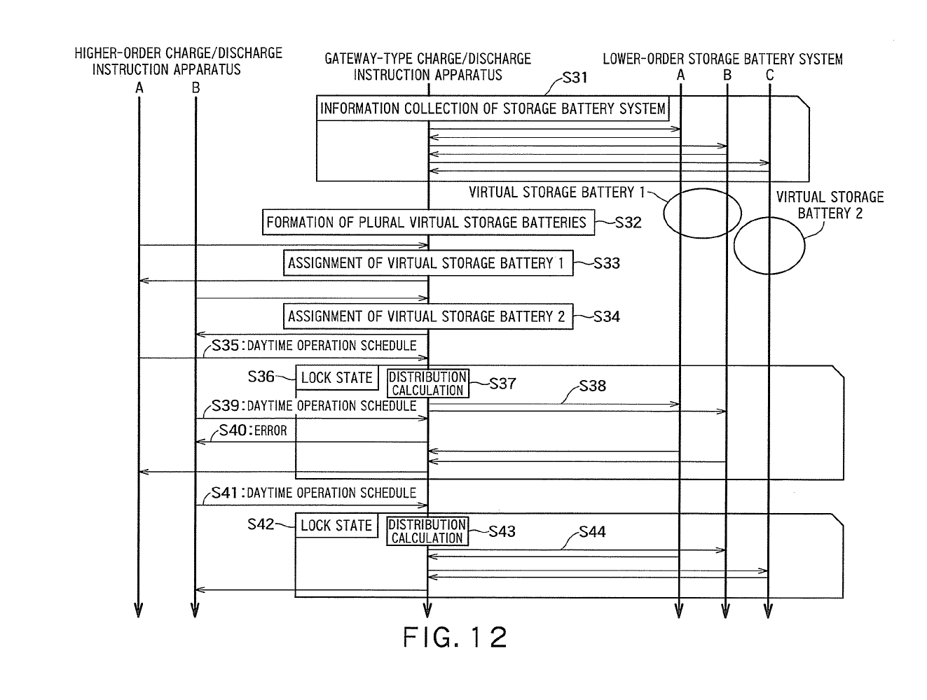

FIG. 12 illustrates an operation example of a gateway charge/discharge instruction apparatus according to the present embodiment.

The gateway charge/discharge instruction apparatus collects information of the storage battery systems A, B and C (S31) and generates the virtual storage batteries 1 and 2 (S32). The storage battery systems A and B are assigned to the virtual storage battery 1 and the storage battery systems B and C are assigned to the virtual storage battery 2.

The virtual storage battery 1 is assigned to the higher-order charge/discharge instruction apparatus A and the virtual storage battery 2 is assigned to the higher-order charge/discharge instruction apparatus B (S33 and S34). Subsequently, when an instruction such as plan information (i.e. daytime operation schedule) related to a daytime operation is transmitted from the higher-order charge/discharge instruction apparatus A to the virtual storage battery 1 of the gateway charge/discharge instruction apparatus (S35), the gateway charge/discharge instruction apparatus checks whether the storage battery systems forming the virtual storage battery 1 is not used in the other higher-order charge/discharge instruction apparatus. After the check, it causes the virtual storage battery 2, which uses part of the storage battery systems forming the virtual storage battery 1, to be in a lock state (S36), and performs distribution calculation (S37) and transmits a control order (S38). By this means, when the higher-order charge/discharge instruction apparatus B transmits an instruction such as a daytime operation schedule (S39), it returns an error (S40) to show that part of the storage battery systems belonging to the virtual storage battery 2 is controlled by another higher-order charge/discharge instruction apparatus.

After a moment, when the higher-order charge/discharge instruction apparatus B transmits plan information (S41), since the lock state is released at this time, the gateway charge/discharge instruction apparatus checks whether the storage battery systems forming the virtual storage battery 2 are not used in another higher-order charge/discharge instruction apparatus. After the check, the virtual storage battery (the virtual storage battery 1 in this case) using part of the storage battery systems forming the virtual storage battery 2 is caused to be in a lock state (S42) to perform distribution calculation (S43) and transmits a control order (S44).

Thus, according to the second embodiment, a part of storage battery systems is allowed to overlap between virtual storage batteries while a virtual storage battery targeting a common storage battery system with the currently used virtual storage battery is set in a lock state. Accordingly, in a case where a use request is given from another higher-order charge/discharge instruction apparatus to the virtual storage battery, it is possible to prevent a collision of control orders.

### Third Embodiment

Similar to the second embodiment, the third embodiment is an embodiment in a case where storage battery systems belonging to a plurality of virtual storage batteries are allowed to overlap between the virtual storage batteries. In the present embodiment, in a case where a common storage battery system is operating by an operation instruction of a first higher-order charge/discharge instruction apparatus, when a second virtual storage battery accepts an operation from a second higher-order charge/discharge instruction apparatus, a storage battery system that is not shared between the both apparatuses is separated from the second virtual storage battery to newly recreate a second virtual storage battery. Subsequently, the new recreated second virtual storage battery is assigned to the second higher-order charge/discharge instruction apparatus for control.

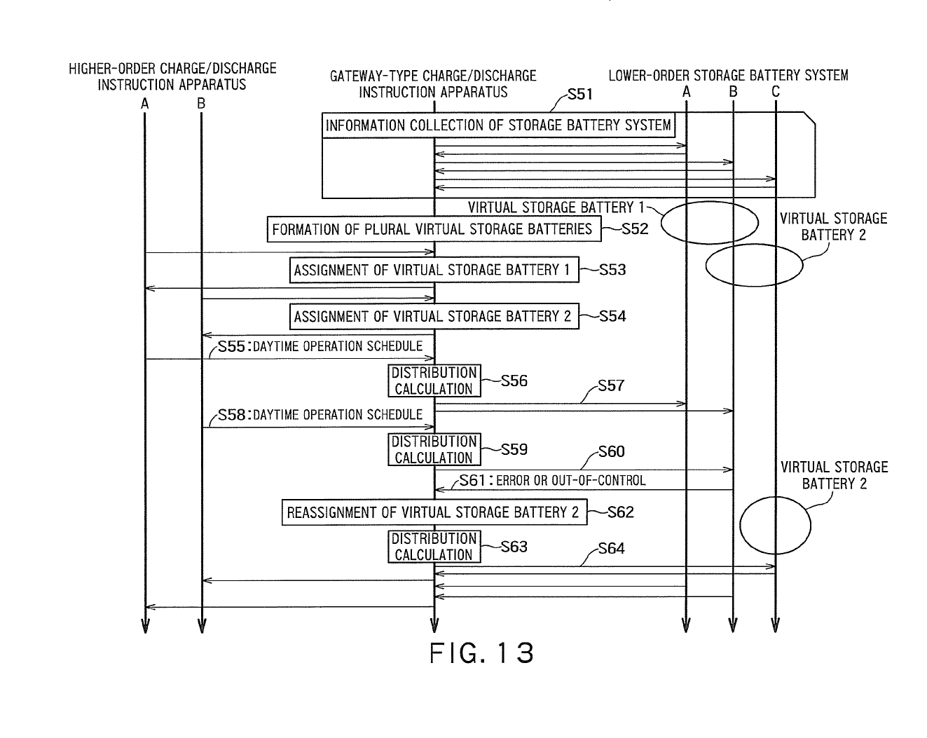

FIG. 13 illustrates an operation example of a gateway charge/discharge instruction apparatus according to the present embodiment.

Similar to the second embodiment, information of the storage battery systems A, B and C is collected (S51) to generate virtual storage batteries 1 and 2 (S52). The storage battery systems A and B are used in the virtual storage battery 1 and the storage battery systems B and C are used in the virtual storage battery 2. The storage battery system B is commonly used between the virtual storage batteries 1 and 2. Also, the virtual storage battery 1 is assigned to the higher-order charge/discharge instruction apparatus A and the virtual storage battery 2 is assigned to the higher-order charge/discharge instruction apparatus B (S53 and S54).

After receiving plan information (e.g. daytime operation schedule) with respect to the virtual storage battery 1 from the higher-order charge/discharge instruction apparatus A (S55), the gateway charge/discharge instruction apparatus performs distribution calculation (S56) and transmits a control order to the lower-order storage battery systems A and B belonging to the virtual storage battery 1 (S57).

Similarly, also from the higher-order charge/discharge instruction apparatus B, a daytime operation schedule with respect to the virtual storage battery 2 is transmitted to the gateway charge/discharge instruction apparatus (S58), and, after distribution calculation (S59), a control order is transmitted to the storage battery systems B and C belonging to the virtual storage battery 2 (S60).

For example, there may be a case where the storage battery system B shared and used between the virtual storage batteries 1 and 2 collisions with content of a control order from a different higher-order charge/discharge instruction apparatus or a case where the storage battery system B is being operated and cannot be controlled. In such a case, it may occur that it is not possible to perform distribution assumed by the gateway charge/discharge instruction apparatus. At this time, an error or an out-of-control response is returned to the gateway charge/discharge instruction apparatus (S61). Alternatively, the response may be omitted.

In this case, a storage battery system, which is not shared with or does not collide with the virtual storage battery 1, is separated from the virtual storage battery 2 to recreate a new virtual storage battery (i.e. virtual storage battery 3). At this time, it may be possible to further add a storage battery system belonging to another virtual storage battery or further add a storage battery system that is not a virtualization target yet. When a request of a battery characteristic or the like is made from a higher-order charge/discharge instruction apparatus, a storage battery system may be added to satisfy the request. In the example in FIG. 13, the storage battery system C is extracted from the virtual storage battery 2 to recreate a new virtual storage battery 2. Subsequently, a distribution calculation is performed again for the recreated virtual storage battery 2 (S63) and a control order is transmitted to the storage battery system C belonging to the new virtual storage battery 2 (S64). Here, if there is a virtual storage battery that is not assigned yet, it is possible to assign the virtual storage battery to the higher-order charge/discharge instruction apparatus B.

Thus, according to the third embodiment, by extracting a storage battery system that is not shared with a currently used virtual storage battery 1 from a virtual storage battery 2 and by recreating a new virtual storage battery 2, it is possible to prevent a collision of control orders between storage battery systems, and form a large-scale system. Also, by extracting other storage battery system(s) than a storage battery system that is being operated and cannot be controlled, and by recreating a new virtual storage battery 2, it is possible to prevent a collision of control orders between storage battery systems and form a large-scale system.

The gateway charge/discharge instruction apparatus which have been heretofore described may also be realized using a general-purpose computer device as basic hardware. That is, each unit in the apparatus can be realized by causing a processor mounted in the above described computer device to execute a program. In this case, the apparatus may be realized by installing the above described program in the computer device beforehand or may be realized by storing the program in a storage medium such as a CD-ROM or distributing the above described program over a network and installing this program in the computer device as appropriate. Furthermore, the storage in the apparatus may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A gateway apparatus comprising:
a managing unit configured to manage at least one storage battery group including a set of one or more storage battery systems selected from a plurality of storage battery systems;
an assigning unit configured to assign a first storage battery group, which is one of the at least one storage battery group, to a first charge/discharge instruction apparatus;
a receiving unit configured to receive an instruction related to charge or discharge from the first charge/discharge instruction apparatus;
a generating unit configured to generate a first control order that is a control order for the storage battery systems belonging to the first storage battery group, based on the instruction; and
a transmitting unit configured to transmit the first control order to the storage battery systems belonging to the first storage battery group.

2. The gateway apparatus according to claim 1, wherein:
a second storage battery group that is one of the at least one storage battery group does not include a same storage battery system as that of the first storage battery group;
the assigning unit assigns the second storage battery group to a second charge/discharge instruction apparatus;
the receiving unit receives an instruction related to charge or discharge from the second charge/discharge instruction apparatus;
the generating unit generates a second control order that is a control order for the storage battery systems belonging to the second storage battery group, based on the instruction; and
the transmitting unit transmits the second control order to the storage battery systems belonging to the second storage battery group.

3. The gateway apparatus according to claim 1, wherein:
a second storage battery group that is one of the at least one storage battery group includes at least one same storage battery system as that of the first storage battery group;
the assigning unit assigns the second storage battery group to a second charge/discharge instruction apparatus;
the receiving unit receives an instruction related to charge or discharge from the second charge/discharge instruction apparatus;
the generating unit generates a second control order that is a control order for the storage battery systems belonging to the second storage battery group, based on the instruction;
the transmitting unit transmits the second control order to the storage battery systems belonging to the second storage battery group; and
in a case where the instruction from the second charge/discharge instruction apparatus is received when the storage battery system belonging to the first storage battery group processes the first control order, the generating unit rejects an execution of the instruction.

4. The gateway apparatus according to claim 3, wherein the transmitting unit transmits a report that the execution of the instruction is rejected, to the second charge/discharge instruction apparatus.

5. The gateway apparatus according to claim 1, wherein:
in a case where the managing unit receives a report that it is not possible to execute the first control order from one of the storage battery systems belonging to the first storage battery group, the managing unit selects one or more storage battery systems other than the one storage battery system from the first storage battery group, and generates a third storage battery group including a set of the storage battery systems as selected;
the assigning unit assigns the third storage battery group to the first charge/discharge instruction apparatus;
the generating unit generates a third control order that is a control order for the storage battery systems belonging to the third storage battery group; and
the transmitting unit transmits the third control order to the storage battery systems belonging to the third storage battery group.

6. The gateway apparatus according to claim 2, further comprising an information providing unit configured to provide first characteristic information and second characteristic information to each of the first charge/discharge instruction apparatus and the second charge/discharge instruction apparatus, where the first characteristic information indicates an overall characteristic of all storage battery systems belonging to the first storage battery group and the second characteristic information indicates an overall characteristic of all storage battery systems belonging to the second storage battery group,
wherein the assigning unit assigns the first storage battery group to the first charge/discharge instruction apparatus in response to an assignment request of the first storage battery group from the first charge/discharge instruction apparatus and assigns the second storage battery group to the second charge/discharge instruction apparatus in response to an assignment request of the second storage battery group from the second charge/discharge instruction apparatus.

7. The gateway apparatus according to claim 2, wherein:
based on a battery characteristic condition requested by the first charge/discharge instruction apparatus, the managing unit generates the first storage battery group by selecting one or more storage battery systems among the plurality of storage battery systems such that an overall characteristic of all storage battery systems belonging to the first storage battery group satisfies the battery characteristic condition; and
based on a battery characteristic condition requested by the second charge/discharge instruction apparatus, the managing unit generates the second storage battery group by selecting one or more storage battery systems among the plurality of storage battery systems such that an overall characteristic of all storage battery systems belonging to the second storage battery group satisfies the battery characteristic condition.

8. A charge/discharge system comprising:
a plurality of storage battery systems;
a gateway apparatus; and
a first charge/discharge instruction apparatus,
wherein the gateway apparatus comprises:
a managing unit configured to manage at least one storage battery group including a set of one or more storage battery systems selected from the plurality of storage battery systems;
an assigning unit configured to assign a first storage battery group, which is one of the at least one storage battery group, to the first charge/discharge instruction apparatus;
a receiving unit configured to receive an instruction related to charge or discharge from the first charge/discharge instruction apparatus;
a generating unit configured to generate a first control order that is a control order for the storage battery systems belonging to the first storage battery group, based on the instruction; and
a transmitting unit configured to transmit the first control order to the storage battery systems belonging to the first storage battery group.

9. A method comprising:
managing at least one storage battery group including a set of one or more storage battery systems selected from a plurality of storage battery systems;
assigning a first storage battery group, which is one of the at least one storage battery group, to a first charge/discharge instruction apparatus;
receiving an instruction related to charge or discharge from the first charge/discharge instruction apparatus;
generating a first control order that is a control order for the storage battery systems belonging to the first storage battery group, based on the instruction; and
transmitting the first control order to the storage battery systems belonging to the first storage battery group.
